(19) United States
(12) Patent Application Publication
(10) Pub. No.: US 2016/0266583 A1
(43) Pub. Date: Sep. 15, 2016

(54) SPEED SENSITIVE SCAVENGE FLOW CONTROL

(71) Applicant: BorgWarner Inc., Auburn Hills, MI (US)

(72) Inventor: Gerard M. Light, Marshall, MI (US)

(21) Appl. No.: 14/656,632

(22) Filed: Mar. 12, 2015

(51) Int. Cl. G05D 7/01

(52) U.S. Cl. CPC G05D 7/018

(57) ABSTRACT

A biased spool valve restrictor member for positioning in the scavenge channel in a viscous fluid fan drive where it can restrict the flow of scavenge pump-out at low fan speed, and thereby improving the ability of the fan drive to engage at such speeds.

### TECHNICAL FIELD

The present invention relates to viscous fan drives, and more particularly in controlling the scavenge flow of viscous fan drives.

### BACKGROUND

Conventional viscous fan drives with bimetal control have the fluid reservoir located on the output side of the drive where it rotates at fan speed. When the fluid valve opens, centrifugal force drives the viscous fluid from the reservoir into the shear labyrinth. The rate of fill of the fluid is proportional to the fan speed. The fluid control valve is typically controlled by a thermostatic (bimetal) coil that responds to the temperature of the air that has passed through the radiator.

The viscous fluid is returned to the reservoir via a pump that uses slip speed as the driving force. As slip speed increases, pump effectiveness and flow rate increases. The pump-out rate is proportional to the slip space. The pump is always active. In order to engage the fan drive, the fill rate should be greater than the pump out rate.

Since an engine cooling fan consumes power, it impacts fuel economy. Thus, there is a desire to minimize fan speed to maximize fuel economy. As fan speed is reduced, however, the fill rate is reduced and the pump-out rate increases. The net result is that the response time for the fan drive to engage becomes slower. This can cause an engine to overheat, especially when the vehicle is pulling a heavy load or going uphill.

Thus, there is a need for a device and system for reducing the pump out rate as the fan speed is reduced. It is an object of the present invention to meet this need.

### SUMMARY OF THE INVENTION

The present invention meets the above object and provides a system that reduces the decrease in pump-out rate as the fan speed is reduced or the fan speed is low. The invention provides a biased flow restrictor which, when positioned in the scavenge pump out channel of a viscous fan drive, restricts fluid flow when the fan speed is reduced or low.

In a preferred embodiment of the invention, the flow restrictor member includes a cylindrical spool valve member and a compression spring. In use, the speed valve member has a plurality of openings and is positioned adjacent a port in the scavenge channel in the viscous fan clutch drive mechanism. When the flow restrictor is positioned in the fluid flow at low speeds, the spring forces the spool valve member radially inward misaligning the openings with the scavenge outlet port. This restricts the fluid flow and prevents the fan speed from decreasing too much. However, when the fan speed increases or is high, the spring is compressed due to centrifugal force and the speed valve member is forced radially outward where the openings in the spool valve are aligned with the scavenge port. This permits normal flow through the channel.

Additional benefits and features of the invention will become apparent from the following description of the invention when viewed in accordance with the accompanying drawings and appended claims.

### BRIEF DESCRIPTION OF THE DRAWINGS

FIG. 1 depicts in cross-section an exemplary viscous clutch fan drive with which the present invention is utilized.

FIG. 2 is a perspective view of the preferred embodiment depicted in FIG. 1.

FIG. 3 is an exploded view of the embodiment of the invention depicted in FIGS. 1 and 2.

FIGS. 4 and 5 depict the functioning of the embodiment of the invention shown in FIG. 1.

### DESCRIPTION OF THE PREFERRED EMBODIMENTS

Conventional bimetal controlled viscous fan drives have the fluid reservoir located on the output side of the drive (rotates at fan speed). When the valve opens, centrifugal force drives fluid from the reservoir into the shear labyrinth. Fluid is returned to the reservoir via a pump that uses slip speed (rpm) as the driving force.

The purpose of the present invention is to reduce the flow rate of the scavenge pump at low fan speed in order to improve the ability of the fan drive to more quickly engage. At higher speeds, the present invention allows full pump flow which is needed for optimum pump-out performance.

Engine cooling fans consume power. Thus, there is a desire to minimize fan speed to maximize fuel economy. In conventional viscous fan drives, however, as fan speed is reduced, the fill rate is also reduced since the pump out rate increases. The net result is that this also reduces the responsive time for the fan to engage.

When fan response time decreases, there is a chance that a vehicle engine can overheat, particularly when the vehicle is pulling a heavy load and/or going uphill. The following scenario emphasizes this point:

A vehicle with a heavy trailer is being driven on flat ground. The fan drive is disengaged and fan speed is very low. Ram air (from vehicle speed) creates adequate airflow through the radiator to satisfy cooling needs. The thermostat is only partially open. Then the vehicle enters a steep grade. Once into the grade, the vehicle speed slows (less ram air), engine power is increased, and engine speed increases as the transmission downshifts. Coolant temperature rises rapidly. The thermostat opens full allowing more hot coolant to flow into the radiator. The bimetal on the fan drive heats up in response to the hot air that has passed through the hot radiator and rotates the valve to open the fluid fill port. As a result, much of the fluid that enters the shear labyrinth is quickly pumped back into the reservoir. The rate of engagement is slowed down to the point where the engine overheats before the fan drive can engage.

The present invention solves this problem by reducing the flow rate in the pump-out (scavenge) channel when the fan speed is reduced or is low. This improves the ability of the fan drive to engage and prevent the engine from overheating.

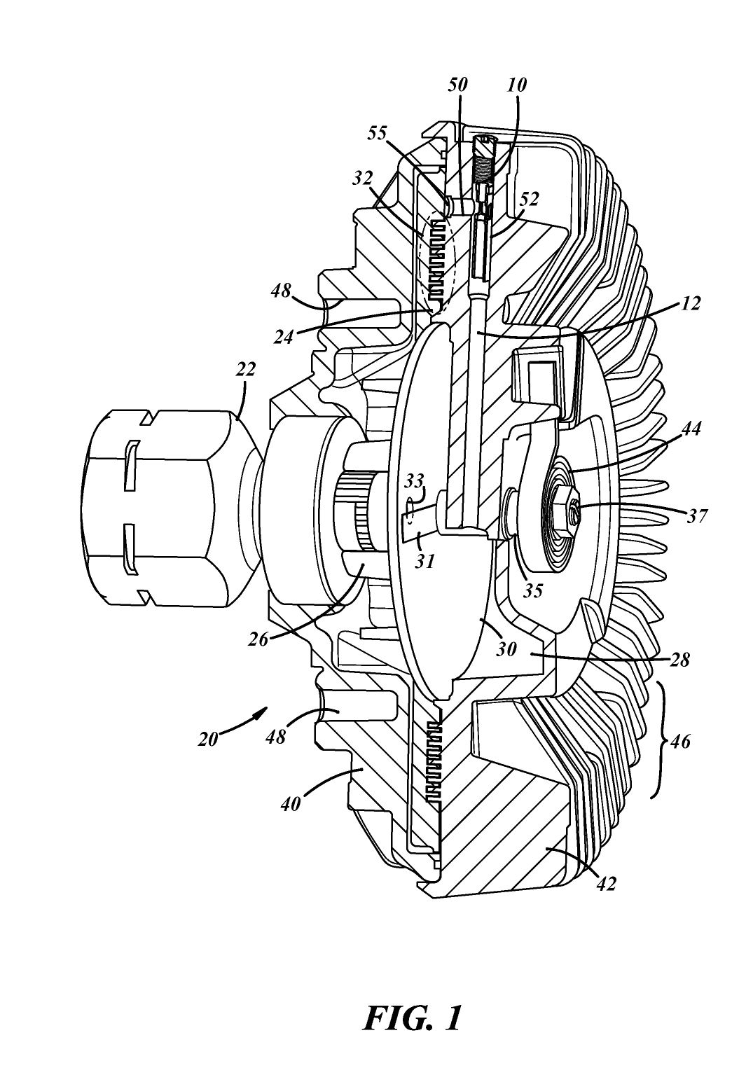

An exemplary viscous fan drive in which the present invention can be utilized is shown in FIG. 1. It is to be understood that this viscous fan drive is only exemplary and is not meant to be limiting relative to the use of the present invention. Instead, the present invention can be used in any viscous fan drive, particularly in any bimetal actuated viscous fan drive.

As shown in FIG. 1, the inventive flow restriction device 10 is shown positioned in the scavenge channel 12 of a bimetal viscous fan drive 20. The fan drive has a shaft member 22 and a valve disk 24 which is attached to the shaft member. Both the shaft member and valve disk rotate at input speed.

The fan drive 20 also has a fluid reservoir 28, a fluid operating chamber 26, a fluid retainer member 30, and a working chamber 32. The outer circumference of the valve disk 24 has a series of lands and grooves which are positioned in the working chamber 32 and which form one-half of the viscous fluid shearing labyrinth. The fan drive further has a body member 40 and a cover member 42 and a bimetal coil member 44. A plurality of cooling fins 46 are positioned on the exterior of the cover member. In use, a cooling fan member (not shown) is attached to the base member 40, such as by a plurality of fasteners positioned in openings 48. The second half of the labyrinth in the working chamber 32 is formed on the inside of the cover member 42. This mates with the first half of the labyrinth formed on the clutch disk 24.

The bimetal coil member 44 is attached directly by shaft member 35 to a valve member 31 positioned on the fluid retainer member 30. The valve member 31 is attached to the lower end of shaft member 35 adjacent the fluid retainer member 30. The valve member 31 is adapted to cover and uncover an opening 33 in the fluid retainer member. When the bimetal coil 44 heats up, it deforms and causes valve arm member 31 to rotate and cover the opening 33. When the opening 33 is covered, viscous fluid is prevented from passing from the fluid reservoir 28 to the fluid operating chamber 26 and onto the working chamber 32. The more fluid that is contained in the labyrinth in the working chamber, the faster the body member, cover member and fan member rotate.

When the bimetal coil is not heated, the arm valve member 31 leaves the opening 33 in the fluid retainer member 30 uncovered. Thus, viscous fluid is allowed to circulate easily through the labyrinth causing the fan member to rotate more slowly. The amount of covering or uncovering of the opening 33 by the valve arm member 31 controls the speed of the fan. The fan has a large range of operating speeds. The changing shape of the bimetal coil as it deforms, provides a range of fluid flow to the working chamber 32 and thus a range of fan speeds.

A wiper member 55 positioned at or near the radial outer end of the working chamber 32 pumps the viscous fluid from the working chamber in a conventional manner and into the scavenge channel 12 through connector channel 50. The scavenge channel 12 returns the viscous fluid to the fluid reservoir 28. Connector channel 50 connects the working chamber 32 to the scavenge channel 12. Fluid that is wiped from the working chamber passes through the passageway 50.

The body member, cover member, fluid retainer member, fluid reservoir and fluid operating chamber all rotate at fan speed.

The flow restriction member 10 is positioned in the radially outer end of the scavenge channel 12. For this purpose, the diameter of the scavenge channel is enlarged at the radially outward end, as shown at 52. The enlarged channel 52 maintains the flow restriction member 10 in a defined area in the scavenge channel.

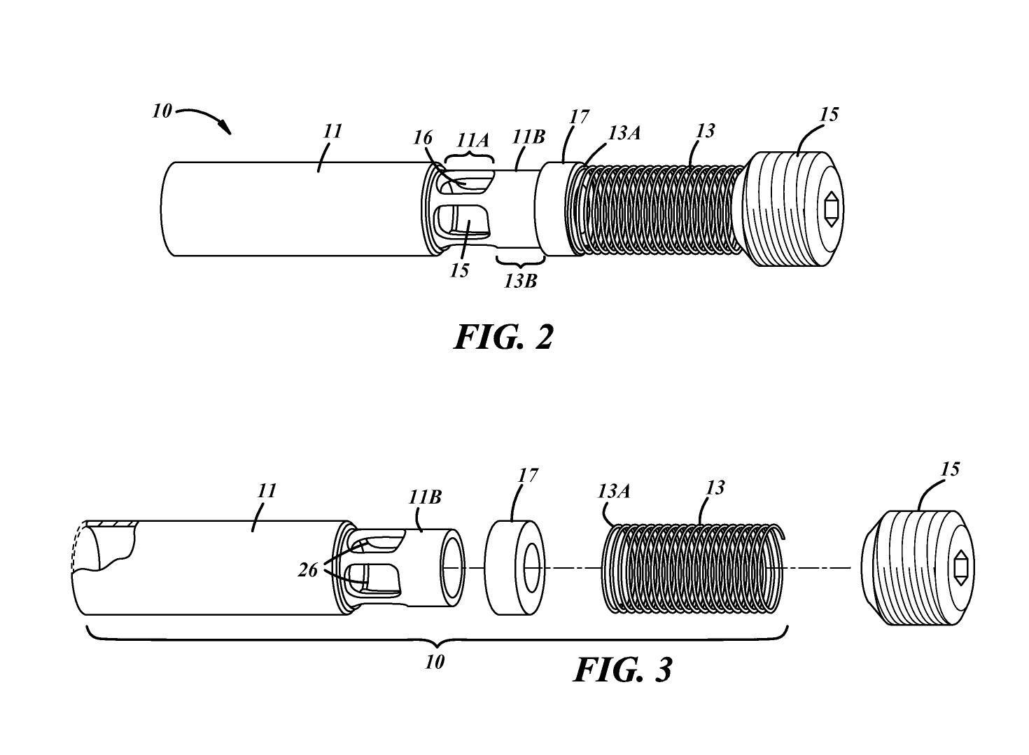

As shown in FIGS. 2 and 3, the flow restriction member 10 includes a hollow spool valve member 11 and a compression coil spring member 13. A plug member 15 also is provided either separate from or attached to the spring member 13. A cup shaped retainer member 17 can also be positioned at one end 13A of the spring member 13. When the flow restrictor member 10 is positioned in the enlarged channel 52 in the cover member 42 of the viscous fan drive, the plug member 15 is used to plug and seal the radially outer end of the scavenge channel 52. The spool valve member 11 has a plurality of openings (or “ports”) 16 in portion 11A and is hollow. Portion 11B of the spool valve does not have any fluid openings. Fluid entering the ports (or openings) 16 passes freely through the hollow interior of the spool valve member 11 and then through the rest of the scavenge channel 12.

The number of openings 16 in the spool valve member 11 is not critical. Four openings 16 are shown in FIGS. 2-3 by way of example.

The flow resistor member 10 can alternatively be provided as a one-piece device with the spool valve member 11 and compression spring member 13 being attached or connected together, with the retainer member 17. It is also possible to have the plug member 15 be attached as well to the spring member in order to maintain the member 10 in position at the radially outward position in the scavenge channel.

Even if the spool valve member 11, compressor spring member 13 and plug member 15 are provided as separate pieces in the scavenge channel, the centrifugal force provided by the fan drive when it rotates will maintain the pieces together at the radially outward location in the scavenge channel.

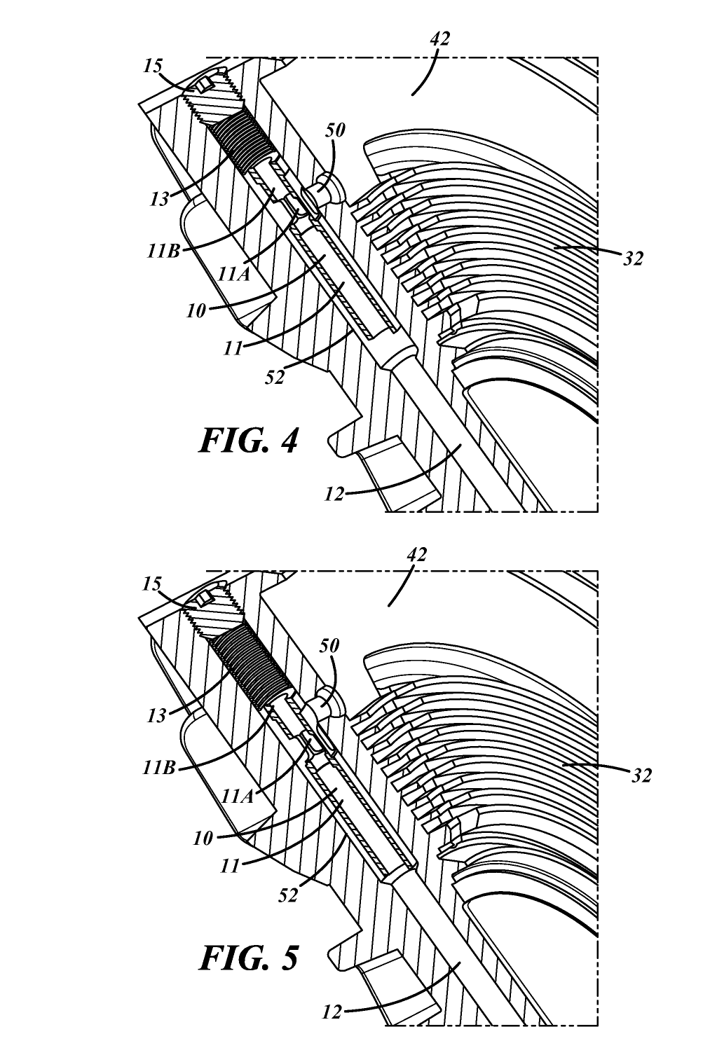

FIGS. 4 and 5 depict the use and functioning of the flow restriction member embodiment 10 of the present invention. When the fan is rotating at a high speed, as shown in FIG. 4, the spring member 13 is compressed due to centrifugal force. This moves the spool valve member 11 radially outward to a position where the openings 16 are in alignment with the passageway 50. This allows normal flow of viscous fluid into and through the scavenge channel 12.

FIG. 5 depicts the use of the flow restriction member 10 at a low fan speed. In this situation, the spring member 13 pushes the spool valve member 11 radially inward. This forces the solid wall portion 11B of the spool valve member to a position where it restricts the flow of fluid from the end of the passageway 50. When the flow of fluid is restricted in this manner, more fluid is forced to remain in the labyrinth causing the cover member, body member and fan member to rotate in a faster manner.

The hollow cylindrical, spool valve member 11, and cap shaped retainer member 17 are made from a metal material, such as steel. Steel or another heavy metal material is preferred so that the centrifugal force can act on it and help force the spring to be compressed at high speeds of rotation. The coil spring member 13 can be made of steel wire material or any other conventional material. The wire diameter of the coil spring member preferably has a diameter in the range of 0.45 to 0.51 mm. The plug member 15 also can be made of any conventional material which will perform the necessary plugging and sealing function, such as steel.

The rate of compression and the weight of the coil spring member, in combination with the weight of the spool valve member, should be calibrated so that the restriction member will function in an optimum manner, as mentioned above.

Although the invention has been described with respect to preferred embodiments, it is to be also understood that it is not to be so limited since changes and modifications can be made therein which are within the full scope of this invention as detailed by the following claims.

What is claimed is:

1. A fluid flow restrictor device comprising:
a spool valve member; and
a compression spring member.

2. The fluid flow restrictor member as described in claim 1 further comprising a plug member.

3. The fluid flow restrictor member as described in claim 1 further comprising a retainer cap member.

4. The fluid flow restrictor member as described in claim 1 wherein said spool valve member comprises a hollow cylinder with a plurality of openings at one end.

5. The fluid flow restrictor member as described in claim 4 wherein four openings are provided in the spool valve member.

6. A fluid flow restrictor member for a viscous fluid fan drive, said fan drive having a scavenge channel in which the fluid flow restrictor member is positioned, said fluid flow restrictor member comprising a spool valve member with a plurality of fluid openings therein and a compression spring member positioned at one end of said spool valve member.

7. The fluid flow restrictor member as described in claim 6 further comprising a plug member connected to said compression spring member.

8. The fluid flow restrictor member further as described in claim 6 comprising a cap retainer member positioned between said spool valve member and said compression spring member.

9. The fluid flow restrictor member as described in claim 6 wherein said plurality of openings are positioned adjacent one end of said spool valve member.

10. The fluid flow restrictor member as described in claim 9 wherein four openings are provided in said spool valve member.

11. A method of preventing a decrease in the output speed of a fan member in a viscous clutch fan drive when the input speed is being decreased, said method comprising the steps of:
providing a viscous clutch fan drive assembly with a working chamber and a scavenge passageway;
providing a flow restriction member in said scavenge passageway;
said flow restriction member comprising a spool valve member with a plurality of openings and a coil spring member.

12. The method as described in claim 11 wherein said scavenge passageway has an inlet port and wherein at low input speed said compression spring biases said spool valve member to a position wherein said openings are not in alignment with said inlet port.
